(19) United States
(12) Patent Application Publication
(10) Pub. No.: US 2022/0015504 A1
(43) Pub. Date: Jan. 20, 2022

(54) ATHLETIC FOOTWEAR AND CLEAT SYSTEMS AND METHODS

(71) Applicant: Peloton Interactive, Inc., New York, NY (US)

(72) Inventors: Nigel Alcorn, New York, NY (US); Jason Poure, New York, NY (US)

(21) Appl. No.: 16/928,946

(22) Filed: Jul. 14, 2020

(51) Int. Cl. A43B 13/22; A43C 15/16; A43B 5/00; B29D 35/14; A43B 13/04

(52) U.S. Cl. CPC A43B 13/223; A43C 15/162; A43B 13/04; B29D 35/142; A43B 5/00

(57) ABSTRACT

Athletic footwear and cleats comprise a first molded layer comprising a rigid substrate including a hole for connecting the molded layer to a shoe, and wherein the first molded layer is adapted to engage binding elements of a pedal, and a second molded layer formed on the bottom portion of the first molded layer, the second molded layer substantially conforming to a shape of a portion of the first molded layer. The second molded layer forms a soft walking surface adapted to provide traction with a walking surface and a raised portion formed thereon, the raised portion adapted to impact float friction during operation. The first molded layer may include nylon, and the second molded layer comprises a thermoplastic elastomer, a thermoplastic polyurethane, and/or a silicone substrate. A third molded layer may be provided to reduce contact friction between the cleat and the pedal of an exercise cycle.

### TECHNICAL FIELD

The present application relates generally to athletic footwear, and more specifically, for example, to improved cleats for use with athletic footwear and exercise equipment.

### BACKGROUND

Cycling shoes for use with indoor exercise equipment (e.g., spin cycles), outdoor road cycling, mountain biking and other cycling equipment and activities typically include stiff soles that attach to a cleat for engaging a pedal on the cycle. The stiff sole is designed to efficiently transfer energy from the user's foot to the pedal, while the cleat engages the bindings of a pedal (e.g., in a “clipless” pedaling system) to connect the cycling shoe to the pedal. During use, a cyclist steps down onto the pedal to engage the cleat with the binding of the pedal. The cyclist may then engage in cycling activities. To disengage the cycling shoe from the pedal, the cyclist typically twists their heel outward or inward to release the cleat from the binding of the pedal. While cycling shoes are designed for efficiency and comfort while cycling, the shoes are often difficult to walk in, particularly indoors. For example, the cleat may make unwanted noise when in contact with the floor, the shoe and/or cleat may slip on the floor, and the cleat may damage some surfaces, such as hardwood floors. These problems are compounded in a group setting, such as a spin cycling class, where multiple cyclists walk to and from the exercise equipment.

In view of the foregoing, there is a continued need for improved cycling shoes and cleats, including solutions that maintain or improve pedaling comfort and efficiency, while facilitating walking activity in between cycling activities.

### SUMMARY

The present disclosure is directed to cleats for use with athletic footwear. In various embodiments, a pair of symmetrical cleats (e.g., cleats that may be used on either foot) adapted for use with exercise equipment include a first molded layer comprising a rigid substrate, wherein the first molded layer forms a hole for connecting the molded layer to a shoe, and wherein the first molded layer is adapted to engage binding elements of a pedal, and a second molded layer formed on a bottom portion of the first molded layer, the second molded layer substantially conforming to a shape of a portion of the first molded layer.

In some embodiments, the second molded layer forms a walking surface that may include a textured surface providing traction on walking surfaces. The second molded layer may include a raised portion formed thereon, the raised portion adapted to impact float friction during operation. In various embodiments, the first molded layer comprises nylon and the second molded layer comprises a thermoplastic elastomer (TPE), a thermoplastic polyurethane (TPU), and/or a silicone substrate. The first molded layer and the second molded layer may be formed through an injection molding process. In some embodiments, the cleat comprises a third molded layer adapted comprising Teflon of similar material to reduce contact friction between the cleat and the pedal.

In various embodiments, a method comprises injecting a hard substrate into a first mold to generate a first molded layer comprising a rigid substrate, including forming a hole in the hard substrate for connecting the molded layer to a shoe, and wherein the first molded layer is adapted to engage binding elements of a pedal, and injecting a soft substrate to generate a second molded layer formed on a bottom portion of the first molded layer, the second molded layer substantially conforming to a shape of a portion of the first molded layer.

The method may further comprise forming a textured walking surface on the second molded layer and forming a raised portion in the second molded layer, the raised portion adapted to impact float friction during operation. In some embodiments, injecting a hard substrate into a first mold comprises injecting nylon and injecting a soft substrate to generate the second molded layer comprises injecting a thermoplastic elastomer (TPE), a thermoplastic polyurethane (TPU), and/or a silicone substrate. The first molded layer and the second molded layer may be formed through an injection molding process comprising a single mold. In some embodiments, the method further comprises injecting a low friction substrate, such as Teflon, to generate a third molded layer adapted to reduce contact friction with the pedal.

The scope of the present disclosure is defined by the claims, which are incorporated into this section by reference. A more complete understanding of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

Aspects of the disclosure and their advantages can be better understood with reference to the following drawings and the detailed description that follows. It should be appreciated that like reference numerals are used to identify like elements illustrated in one or more of the figures, wherein showings therein are for purposes of illustrating embodiments of the present disclosure and not for purposes of limiting the same. The components in the drawings are not necessarily to scale, emphasis instead being placed upon clearly illustrating the principles of the present disclosure.

FIG. 1 illustrates an example athletic shoe and cleat, in accordance with one or more embodiments of the present disclosure.

FIGS. 2A, 2B and 2C illustrate an example athletic shoe and cleat from side, bottom and perspective views, respectively, in accordance with one or more embodiments of the present disclosure.

FIG. 3A illustrates a perspective view of an example cleat and pedal, in accordance with one or more embodiments of the present disclosure.

FIG. 3B illustrates an exploded view of an example cleat and pedal, in accordance with one or more embodiments of the present disclosure.

FIG. 3C illustrates a top view of an example cleat and pedal, in accordance with one or more embodiments of the present disclosure.

FIG. 3D illustrates a bottom view of an example cleat and pedal, in accordance with one or more embodiments of the present disclosure.

FIG. 3E illustrates a front view of an example cleat and pedal, in accordance with one or more embodiments of the present disclosure.

FIG. 3F illustrates a back view of an example cleat and pedal, in accordance with one or more embodiments of the present disclosure.

FIG. 3G illustrates a right side view of an example cleat and pedal, in accordance with one or more embodiments of the present disclosure.

FIG. 3H illustrates a left side view of an example cleat and pedal, in accordance with one or more embodiments of the present disclosure.

FIG. 3I illustrates a bottom perspective view of an example cleat, in accordance with one or more embodiments of the present disclosure.

FIG. 3J illustrates a top perspective view of an example cleat, in accordance with one or more embodiments of the present disclosure.

FIG. 3K illustrates a side view of an example cleat, in accordance with one or more embodiments of the present disclosure.

FIG. 4 illustrates an exploded view of an example cleat, in accordance with one or more embodiments of the present disclosure.

FIGS. 5A, 5B and 5C are perspective views of an example cleat, in accordance with one or more embodiments of the present disclosure.

FIGS. 6A and 6B are example cleats, in accordance with one or more embodiments of the present disclosure.

FIG. 7 is a flow diagram illustrating an example process for manufacturing a clear, in accordance with one or more embodiments of the present disclosure.

### DETAILED DESCRIPTION

The present disclosure describes various examples of athletic shoes and cleats for use with exercise equipment. The athletic shoe may be used, for example, with a cycling apparatus (e.g., indoor exercise cycle, outdoor road bike, outdoor mountain bike, etc.) or other apparatus where attaching the bottom of a shoe to the apparatus is desired. The shoe is adapted to attach to a cleat that is further adapted to engage with a binding of an exercise apparatus. In operation, the cleat is inserted into the binding (e.g., stepping into the binding of a pedal with the shoe) for operation of the exercise apparatus and detached from the binding when further use of the exercise apparatus is no longer desired (e.g., by a predetermined action such as twisting the heel of the athletic shoe inward or outward to release the cleat). The athletic shoe, cleat and binding are adapted to work together to effect desired use of the exercise apparatus.

In various embodiments, the athletic shoe and/or cleat are adapted to facilitate standing and/or walking by the user before and after use of the exercise apparatus. Conventional cleats are constructed of a hard material that may include metal or hard polymer substrate to functionally engage the exercise equipment during exercise. However, these conventional cleats may damage indoor surfaces and be uncomfortable and/or dangerous for the user to walk in. In some embodiments disclosed herein, the cleat includes a soft material bottom comprising a substrate having friction properties that improves traction on slippery surfaces, provides a comfortable and quiet walking experience compared to conventional cleats, and is adapted to protect walking surfaces (e.g., indoor walking surfaces such as hardwood floors) from potential damage from the cleat and/or athletic shoe. In some embodiments, the soft material bottom includes a textured surface to further improve traction on slippery surfaces.

In various embodiments, a cleat is formed as a single piece using an injection molding process that includes two or more substrates. In some embodiments, the body of the cleat is formed using a hard polymer substrate (e.g., nylon, a polyamide, etc.), and a bottom layer is formed using a soft substrate (e.g., thermoplastic elastomers (TPEs), thermoplastic polyurethanes (TPUs), silicone, etc.) with a soft textured surface to facilitate walking on indoor surfaces, and a soft bumper or pad in a middle portion of the cleat to control the float friction of the cleat when attached to the pedal. In contrast, conventional cleats are typically assembled from multiple components, including a bumper that may be connected to the hard cleat using a bayonet assembly, screws into the cleat, or other hardware.

In various embodiments, an improved cleat includes a soft walking surface formed over the hard-molded base that provides friction while walking and friction against the pedal while operating the exercise equipment. The soft bumper and soft walking surface are molded directly to the hard substrate of the cleat body to chemically and mechanically bond the soft elements to the cleat. Various improvements of the present disclosure include improved cleat assembly, an improved walkable cleat with improved anti-slip features, and improved methods of manufacturing a cleat as single part comprising a soft surface on the bottom of the cleat.

In some embodiments, the cleat is adapted for indoor spin cycling and attaches with hardware to the bottom of an indoor cycling shoe. In various embodiments, the cleat may be provided with a shoe and/or as a replacement cleat for a shoe. In some embodiments, the cleat is adapted to fit a standard cleat specification, including method connecting the cleat to the shoe. In some embodiments, the cleat is a conventional 3-bolt cleat used for road bikes, spin bikes and other cycles, and attaches to the shoe using a screw or bolt to secure the cleat against the bottom of the shoe. In some embodiments, the cleat is a delta-style cleat, a Shimano Pedaling Dynamics (SPD) style cleat, or other cleat style, that attaches to shoes using conventional coupling mechanisms of standard cleat designs, which may include a washer and screw, allowing the cleat to fit various shoe designs.

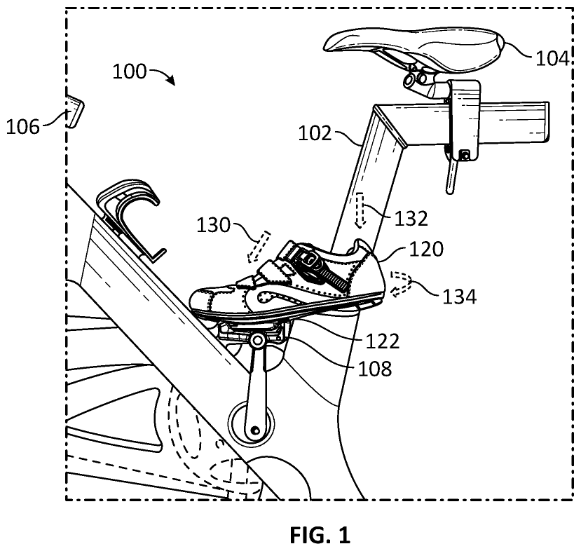

Embodiments of the present disclosure will now be described in further detail with reference to the figures. FIG. 1 illustrates an example exercise apparatus engaged with an athletic shoe and cleat, in accordance with one or more embodiments. As illustrated, an exercise cycle 100 includes a frame 102, a seat 104, handle bars 106, and pedals 108 for turning a crankshaft. Other equipment, not shown, may also be available such as a flywheel, a resistance adjustment mechanism, a brake, a display screen, and/or other devices and components. A user (not shown) wears a shoe 120 with a cleat 122 that engages a binding of the pedal 108 to maintain a connection between the shoe 120 and the pedal 108 during operation of the exercise cycle 100. To connect the shoe 120 to the pedal 108, the user positions the forward portion of the cleat 122 into the binding as indicated by arrow 130, then steps down as indicated by arrow 132 to engage the rear portion of the cleat 122 into the rear portion of the binding, which may include a bias element (e.g., a spring) that maintains the cleat 122 in a proper position during operation. To disengage the cleat 122 from the pedal 108, the user twists the heel of the shoe 120 outward as indicated by arrow 134. In various embodiments, the shoe 120, cleat 122 and pedal 108 may be configured to engage/disengage using other appropriate movements.

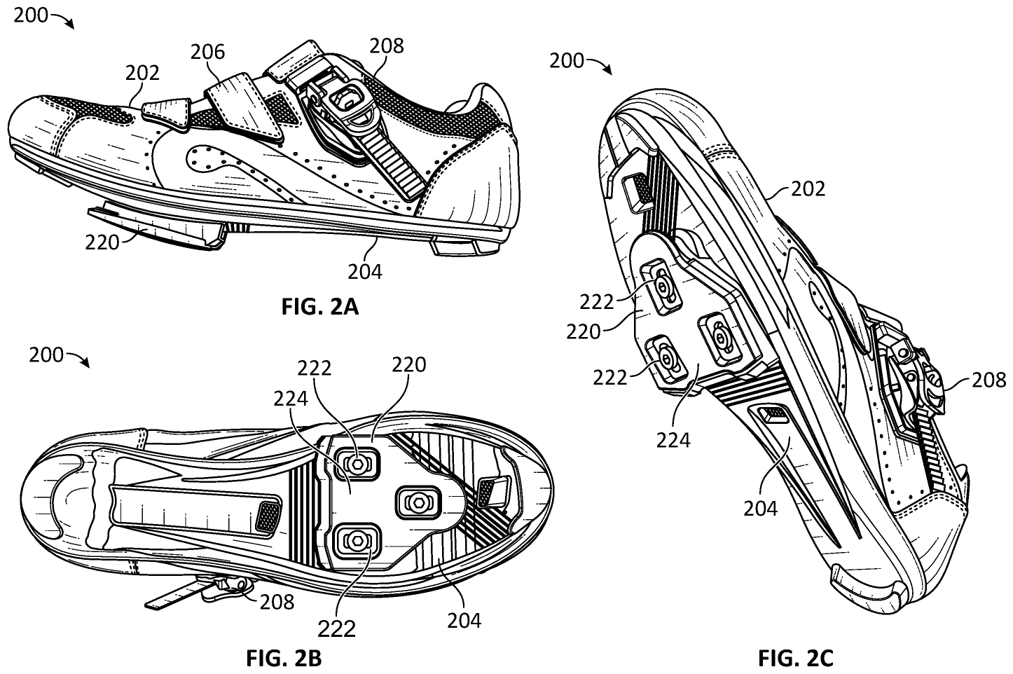

Referring to FIGS. 2A, 2B and 2C, an example of an athletic shoe 200 and cleat 220 will now be described in accordance with one or more embodiments. The athletic shoe 200 includes an upper portion 202 adapted to receive and secure the user's foot, and a sole 204. The upper portion 202 may be constructed of one or more materials suitable for use in an athletic shoe such as leather, suede, synthetic leather, nylon mesh, or other materials. The upper portion 202 may include one or more fastening components such as laces, Velcro straps 206, buckles 208, or other fastening components. The sole 204 is constructed and/or formed of a carbon fiber material or other materials to create a rigid or semi-rigid structure across the bottom of the shoe 200.

The cleat 220 is attached to the bottom of the sole 204 by one or more screws 222 or similar hardware for attaching the cleat 220. In some embodiments, the sole 204 is adapted to receive each screw 222 through a corresponding hole passing through the sole 204, to connect to corresponding hardware on the interior of the shoe 200. In various embodiments, the cleat 220 is removable and/or adjustable using the attachment hardware. The attachment hardware may include other components such as a plate positioned between the head of the screw 222 and the cleat 220, washers, and/or other hardware components.

In some embodiments, the cleat 220 is formed using an injection molding process and is adapted to fit a corresponding binding of a pedal. In some embodiments, the cleat is constructed of a hard substrate, such as glass filled nylon, using a double injected expanded polyethylene mold that adds layers to the hard portion of the cleat. The cleat includes soft textured bottom, which adds a layer of grip and a raised pad 224 in a middle portion (e.g., a square shaped pad, a square pad with a logo as illustrated, etc.) that may be used to control float friction during use of the exercise apparatus. In contrast to conventional systems in which a pad is assembled onto the cleat, the pad 224 of the present embodiment is molded as part of the bottom surface of the cleat. The cleat 220 enables the user to walk on most surfaces without impacting the surface of the rigid portion of the cleat 220. The cleat 220 is manufactured as a single piece and provides grip while walking, an integrated float friction bumper (e.g., pad 224), and is constructed with a hard structure to maintain functionality when engaged with a pedal.

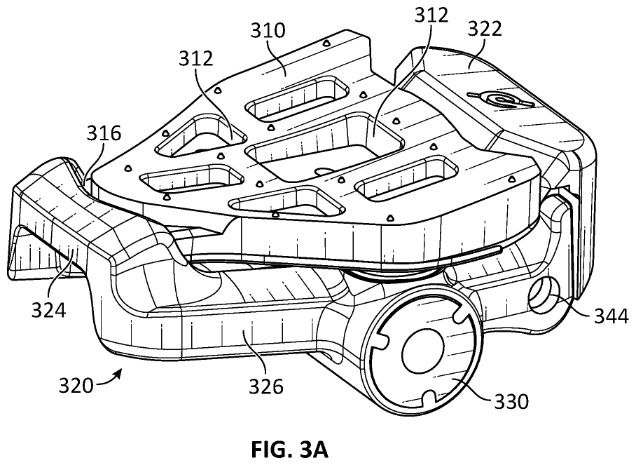

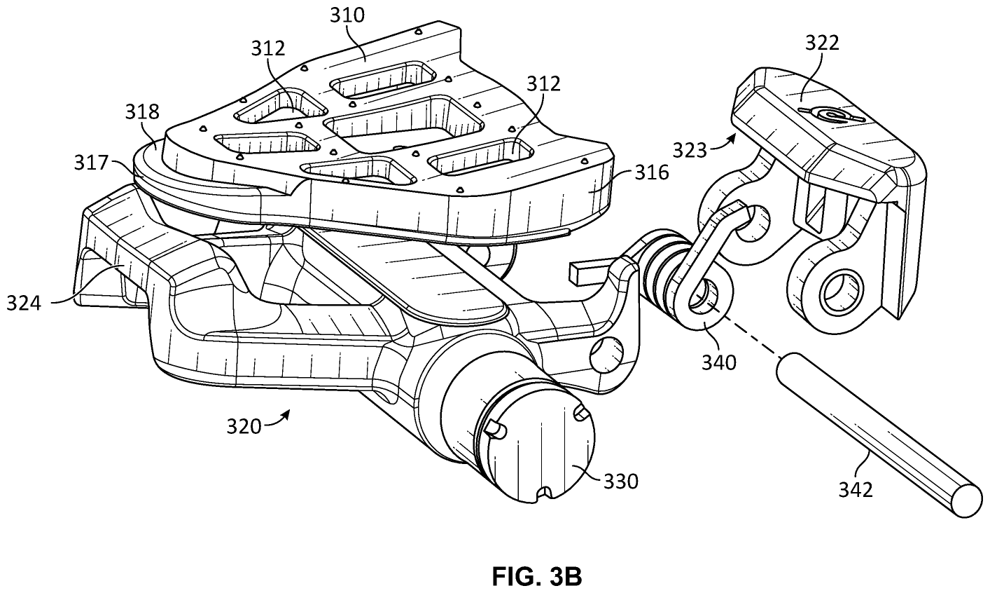

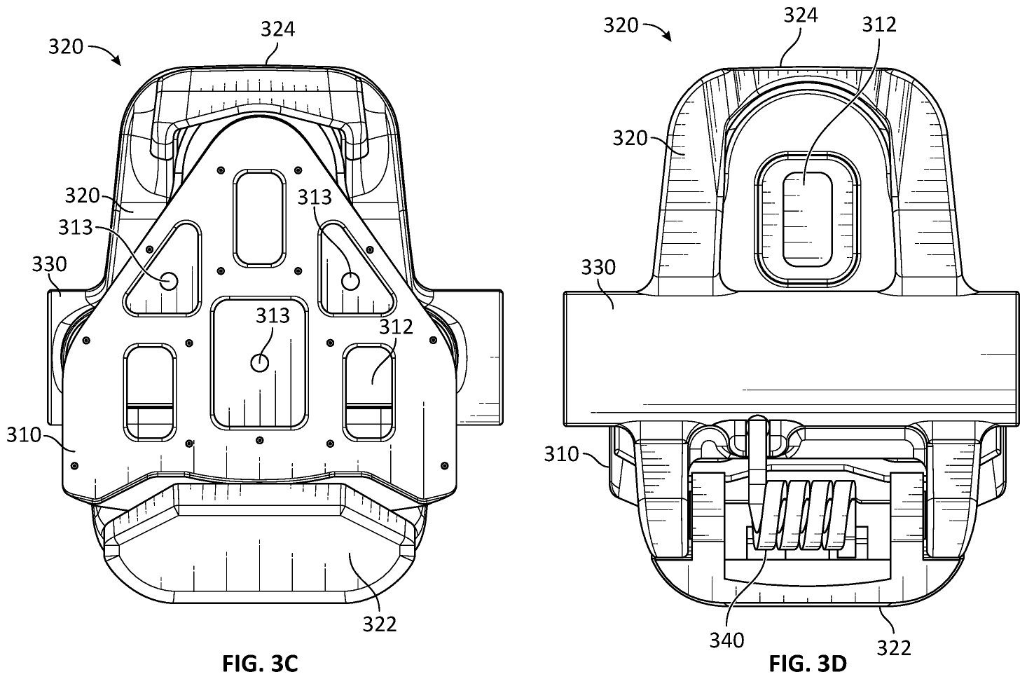

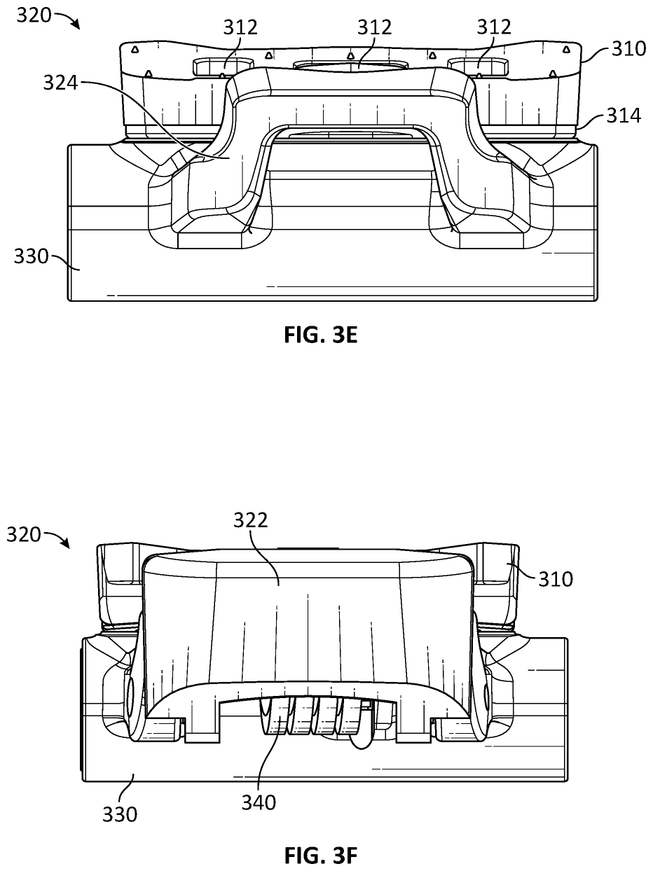

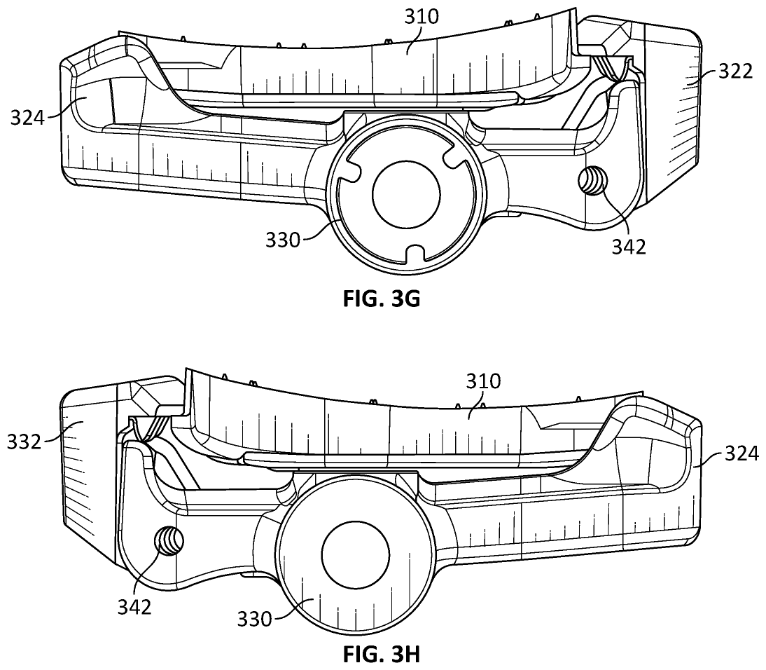

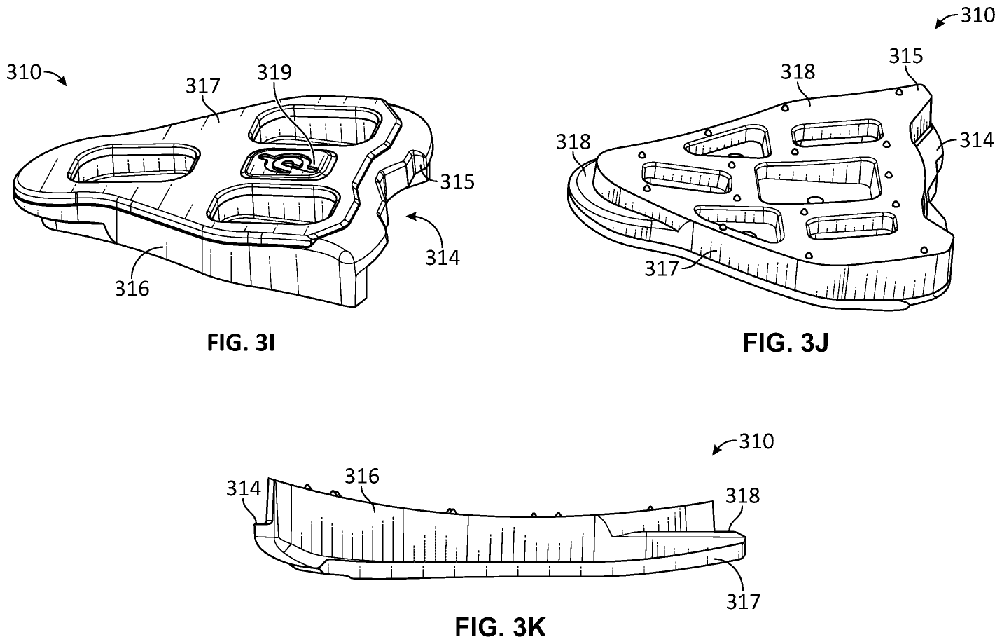

FIGS. 3A-K illustrate various views of an example cleat 310 and pedal 320 in accordance with one or more embodiments. The pedal 320 includes one or more components comprising a pedal structure 326, a heel portion 322 at the rear of the pedal 320, and a toe portion 324 at the front of the pedal 320. The heel portion 322 is attached to the pedal structure 326 at a hinge point 344 (e.g., through a pin 342 or other component) and is biased to rotate inward towards the middle of the pedal structure 326. The heel portion 322 includes a lip 323 which is adapted to cover a lip 314 of the cleat 310 when the heel portion 322 is in a closed position, securing a rear portion of the cleat 310 vertically when the cleat 310 is engaged with the pedal 320. The cleat 310 further includes side portions 315 that extend outside of the heel portion 322, and which are adapted to secure a rear portion of the cleat 310 laterally when the cleat 310 is engaged with the pedal 320. In some embodiments, a bias member 340 may include a torsion spring or other biasing components for biasing the heel portion 322.

The toe portion 324, the heel portion 322, the pedal structure 326 and the bias member 340 are adapted to engage the cleat 310 with the pedal 320, secure the cleat 310 within the pedal 320 during exercise and disengage from the pedal 320. The cleat 310 includes a lip 318 adapted to engage with the toe portion 324 of the pedal 320. In some embodiments, the lip 318 and the toe portion 324 are adapted to secure the lip 318 vertically and horizontally within the toe portion 324, while allowing rotational movement of the cleat 310. To engage the cleat 310 with the pedal 320, the lip 318 is inserted into the toe portion 324 from the middle of the pedal 320. Next, the rear of the cleat 310 is aligned with the heel portion 322 and downward force is applied to the top of the lip 323 of the heel portion 322, which forces the heel portion 322 to rotate outward.

The heel portion 322 is adapted to rotate outwardly about the hinge point 344 in response to the downward pressure, opening space between the heel portion 322 and toe portion 324, allowing the cleat 310 to clear the lip 323 of the heel portion 322. After the cleat 310 clears the lip 323, the bias member 340 forces the heel portion 322 to rotate back to a closed position, securing the cleat 310 on the pedal 320 between the toe portion 324 and the heel portion 322 (e.g., in a position for exercise). The heel portion 322 is further adapted to rotate outwardly about the hinge point 344 in response to a lateral force applied by the cleat 310. In some embodiments, the cleat 310 is adapted to rotate about an axis relative to the toe portion 324, allowing the rear of the cleat 310 to apply a lateral force against the heel portion 322, causing the heel portion 322 to rotate outwardly and the rear of the cleat 310 to clear the heel portion 322 to disengage from the pedal 320.

As illustrated, the pedal 320 further includes a hinge point 330, which may include hardware components for attaching the pedal 320 to a crankshaft or other component of an exercise apparatus. The cleat 310 further includes a plurality of cavities or holes 312, and attachment points 313 for connecting the cleat 310 to an athletic shoe (e.g., the shoes illustrated in FIGS. 1-2C). The cleat 310 further includes a hard portion 316, adapted to engage the pedal 320, maintain an attached shoe in position for operation of the exercise apparatus, and disengage from the pedal 320. The soft portion 317 includes a raised pad 319 and is formed on the bottom of the cleat 310, providing a walking surface.

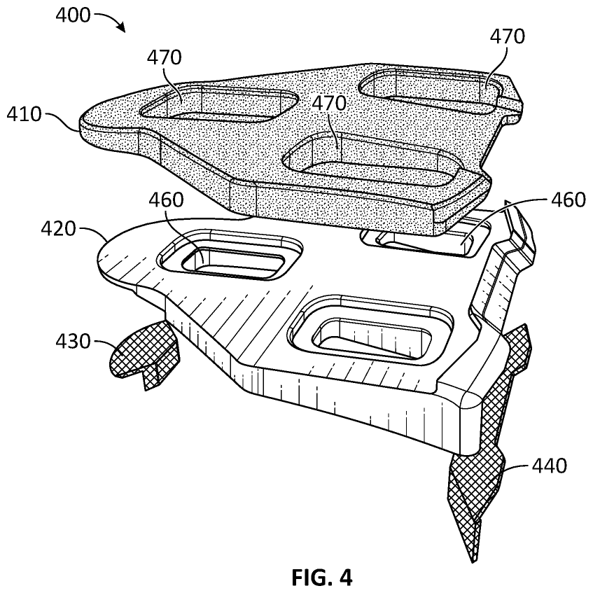

Referring to FIG. 4, another example cleat 400 will now be described in accordance with one or more embodiments. The cleat 400 includes two or more portions, including a bottom portion 410 adapted to provide a comfortable walking surface when not engaged with a pedal, and a top portion 420 adapted to engage with the binding components of a pedal and secure the cleat during use. Other elements may also be included, such as low friction components 430 and 440 which reduce squeaking and other noises from the cleat 400 rubbing against the pedal during use. In some embodiments, bottom portion 410 is formed by a TPU injection molding process. In some embodiments, the bottom portion 410 may be formed from a soft overmolded material for cushioning and grip while walking. In some embodiments, the top portion 420 is molded from a nylon or other material providing a strong rigid structure to engage the cleat with binding components of a pedal. The low friction components 430 and 440 are used to establish low friction contact areas to prevent squeaking and provide the user with a comfortable float during use and may comprise Teflon or other suitable low friction material.

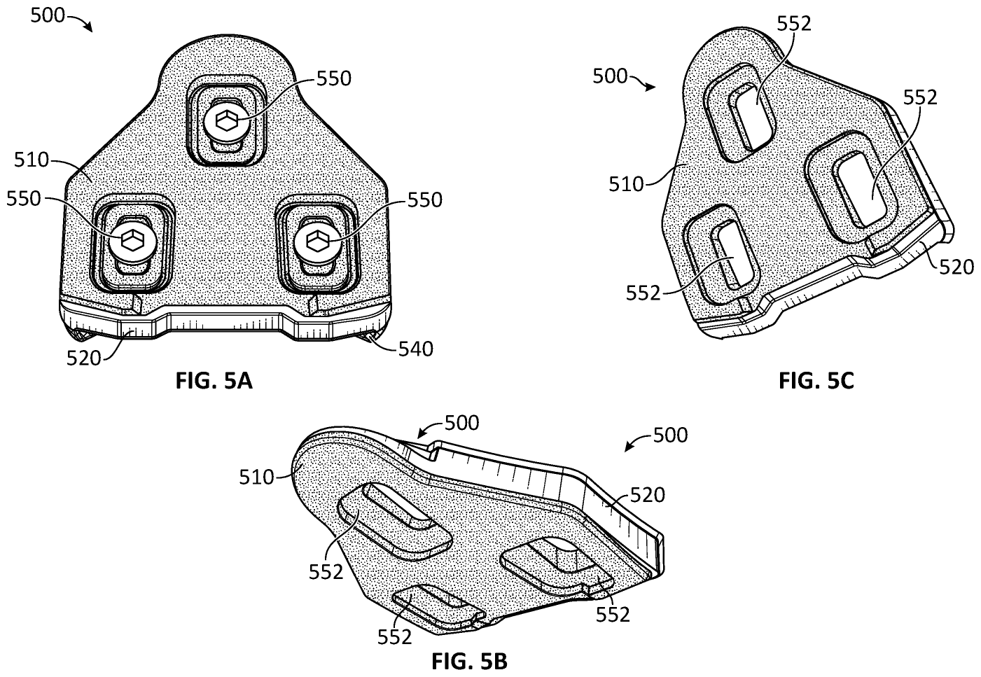

FIGS. 5A-C, illustrate various views of an example cleat 500, in accordance with one or more embodiments. The cleat 500 includes a bottom surface portion 510, which provides a textured protective surface suitable for walking, and a hard structure portion 520, which is adapted to engage the binding elements of a pedal. The cleat 500 also includes low friction elements 540 for contact between the cleat 500 and the pedal when the cleat 500 is engaged with a pedal. The cleat may be attached to a shoe using attachment components 550, such as screws and plates adapted to fit the holes 552 and engage corresponding hardware components in the shoe.

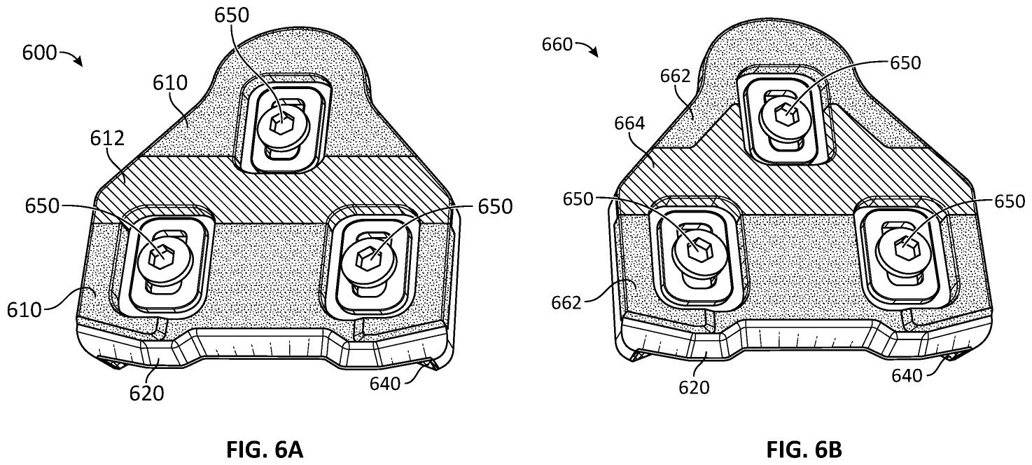

Referring to FIGS. 6A and 6B, other cleat embodiments will now be described. A cleat 600 includes a soft layer 610 that is divided into two or more sections. The bottom surface may also include a second material 612, such as a soft layer using a different material (e.g., a different color) or a surface formed in the hard layer 620. The cleat is attached to the shoe through attachment components 650 and may include low friction components 640. Cleat 660 illustrates another potential arrangement of the top layer including soft layer sections 662 and a middle section 664 formed with a different material.

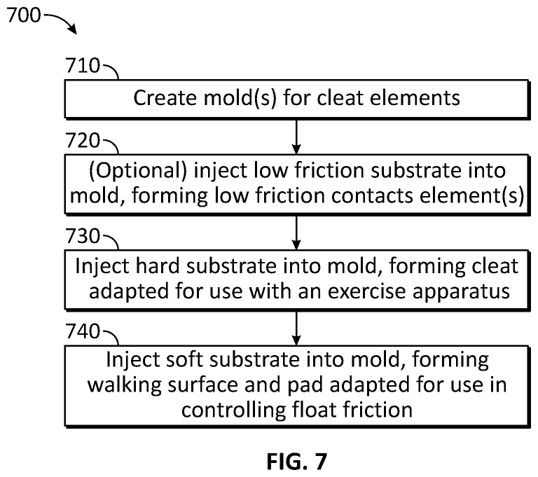

Example processes for manufacturing a cleat in accordance with embodiments of the present disclosure will now be described with reference to FIG. 7. In various embodiments, a process 700 includes a step 710 of creating one or more molds for the cleat elements, including a rigid body portion, a soft portion, and (optionally) a low friction portion. In optional step 720, one or more molds for low friction components are injected using a low friction substrate. In step 730, the low friction components are then positioned in the mold (as necessary) that is injected with a hard substrate to form the cleat which is adapted for use with an athletic shoe and exercise apparatus. In step 740, the formed cleat is positioned in the mold (as necessary) and a soft substrate is injected to form a walking surface and raised pad that is adapted for use in controlling float friction. The resulting cleat is a single molded structure that include a hard portion comprising a first substrate, a soft walking surface comprising a second substrate, and, optionally, low friction components comprising a third substrate.

In some embodiments, the process 700 includes two injection molds that are used to manufacture the cleat. A first mold is adapted to the shape of the stiff component of the cleat and injected with a nylon material. The nylon component is then removed from the first mold and placed in the second mold, which is adapted to the shape of the two-material cleat, including a textured walking surface and a float friction bumper as disclosed herein. The second mold is then injected with TPU or other similar substrate on top of the nylon component.

In other embodiments, a double injection machine may be used including a mold having a slider. The nylon substrate is injected first to form the stiff component of the cleat. The slider may then be removed, the mold flipped over and then the TPU material or other soft substrate is injected to mold the soft layer.

In another embodiment, the process 700 comprises a compression mold process. The stiff nylon layer may be injection molded first and then put into a compression molding machine to compression mold silicone as the soft layer, for example. In various embodiments, TPE, TPU, silicone or materials having similar properties may be used. In some embodiments, the cleat includes a Teflon portion and is manufactured using a three-part process. The Teflon piece may be molded first, then put into the second mold which is injected with nylon, and the resulting cleat is then put that into a third mold and injected the soft substrate on top. The three-part process may also be accomplished using a triple-injection molding machine.

The foregoing description of embodiments is not intended to limit the present disclosure to the precise forms or fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize advantages over conventional approaches and that changes may be made in form and detail without departing from the scope of the present disclosure.

What is claimed is:

1. A cleat comprising:
a first molded layer comprising a rigid substrate, wherein the first molded layer forms a hole for connecting the molded layer to a shoe, and wherein the first molded layer is adapted to engage binding elements of a pedal; and
a second molded layer formed on a bottom portion of the first molded layer, the second molded layer substantially conforming to a shape of a portion of the first molded layer.

2. The cleat of claim 1, wherein the second molded layer forms a walking surface.

3. The cleat of claim 1, wherein the second molded layer comprises a soft substrate having friction properties to produce traction on slippery surfaces and/or a textured surface.

4. The cleat of claim 1, wherein the second molded layer includes a raised portion formed thereon, the raised portion adapted to impact float friction during operation.

5. The cleat of claim 1, wherein the first molded layer comprises nylon.

6. The cleat of claim 1, wherein the second molded layer comprises a thermoplastic elastomer (TPE), a thermoplastic polyurethane (TPU), and/or a silicone substrate.

7. The cleat of claim 1, wherein the first molded layer and the second molded layer are formed through an injection molding process.

8. The cleat of claim 1, further comprising a third molded layer adapted to reduce contact friction between the cleat and the pedal.

9. The cleat of claim 8, wherein the third molded layer comprises Teflon.

10. The cleat of claim 1, wherein the cleat is further adapted for use on an exercise cycle.

11. A method comprising:
injecting a hard substrate into a first mold to generate a first molded layer comprising a rigid substrate, including forming a hole in the hard substrate for connecting the molded layer to a shoe, and wherein the first molded layer is adapted to engage binding elements of a pedal; and
injecting a soft substrate to generate a second molded layer formed on a bottom portion of the first molded layer, the second molded layer substantially conforming to a shape of a portion of the first molded layer.

12. The method of claim 11, further comprising forming a walking surface on the second molded layer.

13. The method of claim 11, further comprising forming a surface on the second molded layer adapted to produce traction on slippery surfaces, the second molded layer comprising a soft substrate having friction properties to produce traction on slippery surfaces and/or a textured surface.

14. The method of claim 11, further comprising forming raised portion in the second molded layer, the raised portion adapted to impact float friction during operation.

15. The method of claim 11, wherein injecting a hard substrate into a first mold comprises injecting nylon.

16. The method of claim 11, wherein injecting a soft substrate to generate the second molded layer comprises injecting a thermoplastic elastomer (TPE), a thermoplastic polyurethane (TPU), and/or a silicone substrate.

17. The method of claim 11, wherein the first molded layer and the second molded layer are formed through an injection molding process comprising a single mold.

18. The method of claim 11, further comprising injecting a low friction substrate to generate a third molded layer adapted to reduce contact friction with the pedal.

19. The method of claim 18, wherein the low friction substrate comprises Teflon.

20. The method of claim 11, further comprising creating a mold for a cleat adapted for use with an exercise cycle.
